(19) United States
(12) Patent Application Publication
(10) Pub. No.: US 2004/0144474 A1
(43) Pub. Date: Jul. 29, 2004

(54) Desiccant stopper

(76) Inventors: Desmond Charles Drummond, Suffolk (GB); Andrew Robertson Drummond, Suffolk (GB)

Correspondence Address: Michael J Gratz, Boyle Fredrickson Newholm Stein & Gratz, 250 Plaza Suite 1030, 250 East Wisconsin Avenue, Milwaukee, WI, 53202, US

(21) Appl. No.: 10/416,074

(22) PCT Filed: Nov. 7, 2001
(86) PCT No.: PCT/GB01/04903

(30) Foreign Application Priority Data
Nov. 7, 2000 (GB) 00/27.155.1

(51) Int. Cl. B29C 65/08; B32B 31/16

(52) U.S. Cl. 156/73.1; 264/248; 264/445

(57) ABSTRACT

A desiccant stopper suitable for use with a bottle of pills or the like, which stopper is of a thermoplastics material and is in the form of a pot at least one end face of which is made from a fibrous fabric sheet of a plastic material attached around its periphery to either the body of the pot or to a lid for the pot body, and wherein the attachment is effected by the sheet being embedded within the material of the body or lid, or both. It also proposes two methods by which such a structure can be manufactured, one involving holding the sheet in place while the body or lid material is injection-molded around it, the other involving sonic fusion of the body/lid material around the sheet.

This invention relates to desiccant stoppers, and concerns in particular stoppers, in the nature of small plugs, that fit into the tops of bottles, such as pill bottles, and absorb any free moisture in the bottle so as to prevent the pills from being damaged thereby.

Desiccant stoppers are used to control the moisture or odour vapour levels of air, within a sealed container, such as a bottle, jar, bag or box, and to control the closed atmosphere to the benefit of sensitive products such as pharmaceuticals packaged within.

Desiccant stoppers are produced in a number of sizes and types relevant to the size and nature of the container and the content to be protected. They must be non-toxic, resistant to water, strong, sterile, and able to provide a microbial barrier.

A desiccant stopper can be constructed in a number of ways, but in the main they follow a similar pattern; they comprise a suitably-sized capsule, rather like a small pot or jar, as the desiccant holder, and after this has been filled with the chosen desiccant it is capped with either a porous-type material wad (such as a thin disc of cardboard) crimped into place, or capped with a moulded plastic lid with cast-in perforations.

Dependant upon their end use, desiccant stoppers can be filled with a wide variety of desiccant-material content. In the event that they are required to control moisture, suitable absorbent materials are silica-gel, or molecular sieve, while for the control of odours, granulated carbon, is used. In some instances, a mixture of each of the mentioned materials will be formulated, and there are a number of proprietary brands of admixtures on the market.

A most important part of any desiccant stopper is the porous membrane section, which allows ingress of the moisture or odour vapours to the desiccant within. In many instances, manufacturers use materials which have not been specifically designed for such membrane use, and adapt materials which are well below the required performance levels. The ideal membrane should be designed to promote optimum permeability, but should also control the escape of fine particles from the sealed container (many desiccant materials used are of inconsistent particle size, and the very smallest of the particles will escape given the opportunity to do so—such as through the inevitable gaps round the edge of a crimped cardboard disk seal). A further requirement is the need to use a sterile material which will not support bacterial penetration or growth. In addition to these qualities the membrane must be strong mechanically, and must remain so during performance.

Some problems experienced with the use of desiccant stoppers relate to the efficiency of the product in use. The injection-moulded plastic used either for the capsule container or for the lid is not permeable to vapours and odours, and will prevent the vapours or odours from reaching the desiccant chemical, in the best method or shortest period of time. Plastic injection moulded lids with small perforations supposedly to allow vapour ingress are in fact poor in performance, and can be subject to flashing (flashing when present will partially or completely block the holes). Likewise, the low efficiency of some wadding materials is such that their permeability for vapours or odours, whilst being acceptable, are not optimum. Consequently, the total efficiency potential of the desiccant is impaired by the nature of the container construction and the wad material being used.

A good mechanical strength for the desiccant stopper is imperative, for damage suffered to the container will allow the content to escape, and cause contamination to the packaged contents. And in fact desiccant materials will escape through poor seals or perforations in plastic parts, even without mechanical damage. The use of wadding, crimped into place to produce a good seal at the outset, is often undone if the desiccant stopper has been subjected to careless handling during transportation or by the packaging filling machinery.

Crimping plastic materials often results in the plastic attempting to recover to the original shape prior to the new crimped form, the resultant relaxation produces poor seal properties.

The present invention proposes a new idea—a stopper in which the “wadding” is a porous plastics material that forms the end face of the stopper itself, the wadding being embedded around its periphery within the stopper material. It also proposes a particular method by which such a structure can reliably be manufactured.

There are nowadays available, breathable plastic materials—olefinic materials, such as polyethylene—which are manufactured using non-moulding techniques. Specifically, by using spinning methods of manufacture, the finished form of the material is as a fabric sheet, of predetermined thickness, when the multiple strands that are employed to compose the matrix overall overlay each other in an ordered manner. This creates a sheet which is apparently solid but which is in fact porous because of the micro spaces which exist between the layered spun fibres. The performance of this type of material is very suitable for use as a permeable wad for desiccant stoppers due to the superb transfer of moisture and odour vapours through the membrane. The microporosity of the material controls dust emission, biological control is inherent due to the nature of the olefin materials from which the membrane is made, and the high tear strength and puncture resistance promotes high mechanical strength, and resistance to damage.

In one aspect, therefore, the invention provides a stopper suitable for use with a bottle of pills or the like, which stopper is of a thermoplastics material and in the form of a pot at least one end face of which is made from a fibrous fabric sheet of a plastics material attached around its periphery to either the body of the pot or to a lid for the pot body, and wherein the attachment is effected by the sheet being embedded within the material of the body or lid, or both.

In a second aspect, the invention provides a first method for the production of such a stopper, in which method the stopper body or lid is injection-moulded, and the fibrous fabric sheet is held in place as this injection-moulding is effected, so that it is totally captured at its outer edges by being overmoulded by the injected plastic which, as it cools, solidifies and forms a solid, integral plastic supporting frame around the sheet embedded therein.

In an alternative second aspect, the invention provides a second method for the production of such a stopper, in which method the fibrous fabric sheet is held in place between the stopper body and the lid, and these two are then fused together so that on cooling and solidifying they form a solid, integral plastic supporting frame around the sheet embedded therein.

The term “embedded” as used herein means that the material of the body and/or lid is not merely attached to either side of the fibrous sheet but actually extends integrally through it—as will clearly be the case if it has been injection-moulded around the sheet, or if it has been fused (so as to flow) together from either side of the sheet.

The stopper is pot-like—that is, it is in the shape of a small container (perhaps 0.75 in [2 cm] across, and 0.188 in [1 cm] deep) for holding in use the desiccant (or other) material contained by the stopper. The stopper can be of any convenient cross-section, but a tubular section is generally most suitable, fitting into most containers of pills or the like.

The stopper ends up as a one-piece object, but for manufacturing purposes it is formed from at least two pieces, namely having a body portion and a lid (or cap) portion that fit sealingly together (starting from three-pieces—an open-ended central ring portion, with a cap at each end—is also be possible). The porous membrane can be integrally formed in either the body or the cap portion (or even in both cap portions), or between the two. The pieces can be joined sealingly together, to make a closed stopper, in any convenient manner. For example, they can be joined by an interference press fit, a snap-over ridge fit, by sonic welding or friction welding, or even by adhesive, or a screw fix.

The flat bottom surface of the body portion, and the flat top surface of the (or each) lid/cap portion, provide the two end faces of the stopper; one or both of these is made from the fibrous fabric sheet of plastics material fused sealingly around its periphery to the main/side parts—the wall portions—of the body or lid appropriately.

Obviously, the material from which the main parts of the stopper body/lid are made and the material from which the fabric sheet is made must be such that they can be welded/fused—that is to say, caused to flow into each other so as to adhere very tightly (and even to intermingle so as to become integral). This is perhaps easiest if the two materials are the general type of material, and specifically if they are in fact the same material. Such a material is that known as Perfecseal HBD 1059B TYVEK, manufactured by Dupont.

Dupont produce a range of materials under the Trademark TYVEK, each of which have specific end uses. Many of the products from this range are suitable for the purposes which are here described.

Another suitable material is that available under the name TEIJIN, and manufactured by Unisel.

The principal purposes of these types of materials are as breathable fabric membranes used to construct bags or sachets, or to cover plastic or foil tray-like containers, to which they are fastened using conventional heat sealing techniques. For best results a large area of contact is required between the two materials which are to be joined.

The use of a TYVEK-type material as the wadding medium has many advantages beyond the capabilities of paper-based wadding, as the available literature on the product describes, but there are problems in the application of the product when using normal wadding techniques.

Paper-based wads are available in varying grades of board, surface finish, and thickness. They are usually at least 0.65 mm thick, when used in small diameter desiccant stoppers (typically 12 mm diameter), and proportionately thicker as diameters increase, and they are stiff in structure. The manufacturing process is similar to that of producing cardboard, but with a fine paper finish for cosmetic reasons. The thickness of the chosen board is important, as it contributes to the structural strength of the finished product. When crimped into place, the wad forms one end of the finished desiccant stopper, where it is the moisture- or odour-permeable window to the capsule. It is also the mechanical end of the desiccant stopper container proper.

Now, TYVEK-type materials are generally very much thinner in comparison to paper-based wad materials, and whilst immensely strong are also extremely flexible. Unfortunately, these features do not allow a simple substitution of TYVEK-type material for a card wad as the flexibility of the material lacks the required mechanical strength found in the latter. In addition these types of material are relatively thin—typically 0.15 mm thick—and they do not compress to a sufficient depth to allow the crimped edge of the plastic to embed into the membrane and anchor if firmly (this is an important requirement of crimping). To be mechanically effective, TYVEK-type materials need to be anchored to the container wall in a completely satisfactory manner.

TYVEK-type materials are also available with an adhesive coating, to facilitate a heat-sealing join to a suitable substrate, but the strength of the seal is directly related to the two surface areas being brought together. If that surface area of sealing is extremely small, then the integrity of the seal is suspect.

The invention proposes two production methods either of which allows the satisfactory formation of a desiccant stopper which employs the rigidity of a plastic injection-moulded capsule for the body of the unit, and the simultaneous moulding in-situ of a suitable—most preferably TYVEK-type—material membrane at one or at both ends of the plastic body to allow the ingress of either moisture or odour vapours through the membrane to the encapsulated desiccant materials contained within. In one method the membrane is held in place as the stopper body or lid is being injection-moulded; the membrane is totally captured at its outer edges by being overmoulded by the injected plastic which, as it cools, solidifies and forms a solid plastic supporting frame around the membrane. In the other method the membrane is held in place between the stopper body and the lid, and these two are then fused together so that on cooling and solidifying they form a solid, integral plastic supporting frame around the sheet embedded therein. This fusing is most conveniently carried out by a sonic welding process (described in more detail hereinafter).

More specifically, then, the invention provides a first method of making a desiccant stopper of the invention by injection moulding of the main stopper parts, in which method:

the fibrous fabric sheet material membrane to be the end wall of the main part is held in place in the mould at the appropriate position relative to where the walls of the main part—which may be either the body portion or the lid portion—will be formed; and

thereafter the walls are injection-moulded, whereby the membrane is totally captured at its outer edges by being overmoulded by the injected plastic which, whilst still liquid, forms around the membrane edges, and, as it cools, solidifies and forms a solid plastic frame around, above or below the membrane.

Also more specifically, the invention provides a second method of making a desiccant stopper of the invention by fusion of the main stopper parts, in which method:

the fibrous fabric sheet material membrane to be the end wall of the main part is held in place between the body portion and the lid portion; and

these two are then fused together by sonic welding so that on cooling and solidifying they form a solid, integral plastic supporting frame around the sheet embedded therein.

This second method relies upon the technique of sonic—that is to say, “ultrasonic”—welding of thermoplastic parts to fuse the body and lid parts together, embedding the membrane therewithin. This technique is now described in more detail.

The principle of ultrasonic assembly involves the use of high-frequency mechanical vibrations transmitted through thermoplastic parts to generate a frictional heat build-up at an interface. The effect of the vibrations causes intense friction between separate but touching parts, causing the materials to heat and melt and weld together.

This vibrational movement is effected by a vibrating component called a “sonotrode”, which is applied at right angles to the surface of a part to be welded. The latter starts to vibrate throughout due to a series of stationary waves, with a maximum amplitude in the area of contact of the two parts to be joined.

After cooling, which is rapid, a solid homogeneous weld results between the two parts of the assembly.

The frequency of vibration of the sonotrode is in the order of 20 kHz, which is outside the limit of perception by the human ear. For this reason, this assembly process is called ultrasonic welding.

The success of this technique depends entirely on the ability of the materials to propagate vibrations without damping them; excellent results can be obtained with suitable thermoplastic rigid materials with a high modulus of elasticity. The method permits the welding of objects of very complex design with a sonotrode which is very simple in form.

The stiffness of the polymer to be welded will influence its ability to transmit the ultrasonic energy to the joint interface. Generally the stiffer a material the better its transmission capability. It is usually not possible to weld materials of different types by ultrasonics, due to the differences in fusion temperature. If the macromolecular structure is not the same for both materials, it will prevent interpenetration.

As specifically applied in the alternative method of the invention, the following points should be borne in mind when using sonic welding.

1. The cap/lid is to be welded to the body, and while this could be butt weld it is preferred to chamfer each abutting face in a matching manner, to form a larger weld surface. Specifically, the edge of the side wall of the cap(s) is moulded to a form recommended as a correct interface profile for ultrasonic welding.

2. The edge of the side wall of the body is correspondingly moulded to a form recommended as a correct interface profile for ultrasonic welding, but also incorporates a section which, when the two plastic components (body & cap) are placed together with the TYVEK type material also in place, acts as a snap fit to temporarily secure the components together, with the underside of the cap in close proximity with the uppermost side of the top edge of the inserted profiled wall of the plastic body.

3. When a membrane window is required at both ends of the stopper, the process described is repeated at the opposite end of the container, which is moulded to suit.

4. It is normally most convenient to assemble the stopper one end at a time, in an upright position, with the end cap placed on top at the time of assembly and ultrasonic welding.

5. Once correctly positioned, with the membrane held therebetween, the body/lid mouldings are ultrasonically welded together to form an integrally-joined capsule. The or each porous membrane is encapsulated within the previously separate components, held in place by the weld between the body and the relevant cap or end.

In these ways the fabric sheet—the TYVEK-type material—is embedded around its periphery within the material forming the stopper body/lid combination. In the first method it is embedded within to the injection-moulded plastic, for at the injection pressures at which the plastic is introduced the plastic penetrates the sheet so that around its edges the membrane is fully incorporated within, and fully supported by, the moulding. In the second method the material of the body and lid portions fuses together—each flows into and intermingles with the other to form an integral whole. In each case the membrane is thus presented as a window to the stopper container's body or lid portion, and thus in use allows unimpeded ingress by moisture or odour vapours. Moreover, reinforced as it is by the plastic frame in which it is totally suspended, the membrane acts as a structural form securing the contents of the stopper from loss or damage.

As can be inferred from what has been said above, there is a choice of TYVEK-type material membrane at one or more positions on the desiccant stopper. Typically the position of a single membrane could be at the end of a stopper, whilst a stopper with two membranes could have them situated one at either end (the purpose of two membranes would be to allow a faster ingress of vapours).

And as also noted above, in the case of a stopper with one membrane only, it will be seen that there is a requirement for two parts. One is the body portion—the receptacle into which the desiccant is placed, while the other is the lid portion. Either may carry the membrane as its end wall, but usually it is more convenient to use the lid for this.

When two membranes are required within a single desiccant stopper the unit can be constructed in a variety of ways. One preferred way is to manufacture the main body of the stopper of a size sufficient to accommodate the total volume of the required fill, and with the membrane integrally moulded into the base of that container. The fill content is then added, and the lid, incorporating a second moulded-in membrane, attached by whatever means thought suitable.

A second preferred way would be to manufacture the unit in three or more parts, comprising two separate cap/lid-like end parts and one (or more) central body part open at both ends. The end parts—each identical in manufacture—incorporate the moulded-in membrane, and each resemble a lid. Assembly of each end part to the central body part then builds the container, into which the fill content is placed before attachment of the second lid end to complete the structure.

Where the several parts of the stopper—the body and one or more end cap/lid—are manufactured separately (and then joined together) it is of course possible to give them different colours. This may be used, if wished, for identification purposes—to indicate, perhaps, either what is inside the stopper (what desiccant is used) or what the stopper is to be employed with (what materials or articles it can be utilised to keep dry, say).

Embodiments of the invention are now described, though by way of illustration only, with reference to the accompanying diagrammatic Drawings (the Drawings are based on cylindrical and circular designs, but other shapes are also suitable for moulding) in which:

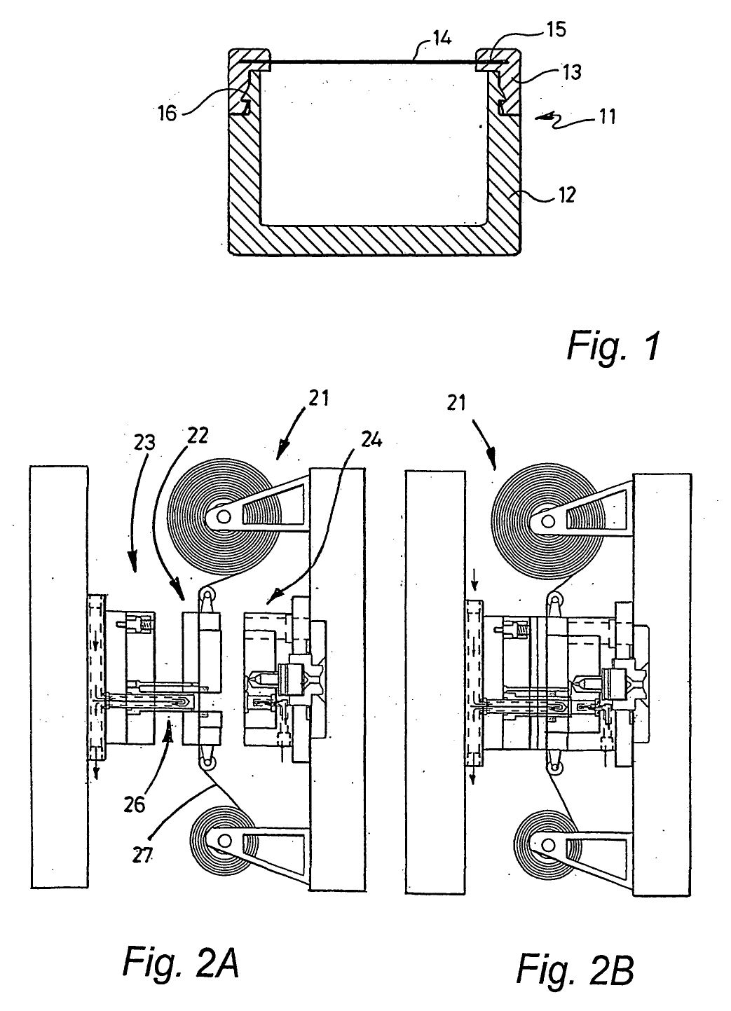

FIG. 1—shows a section through a desiccant stopper of the invention;

FIGS. 2a & B—show general views of the moulding equipment (in the open and the closed states) needed to make the lid of FIG. 1;

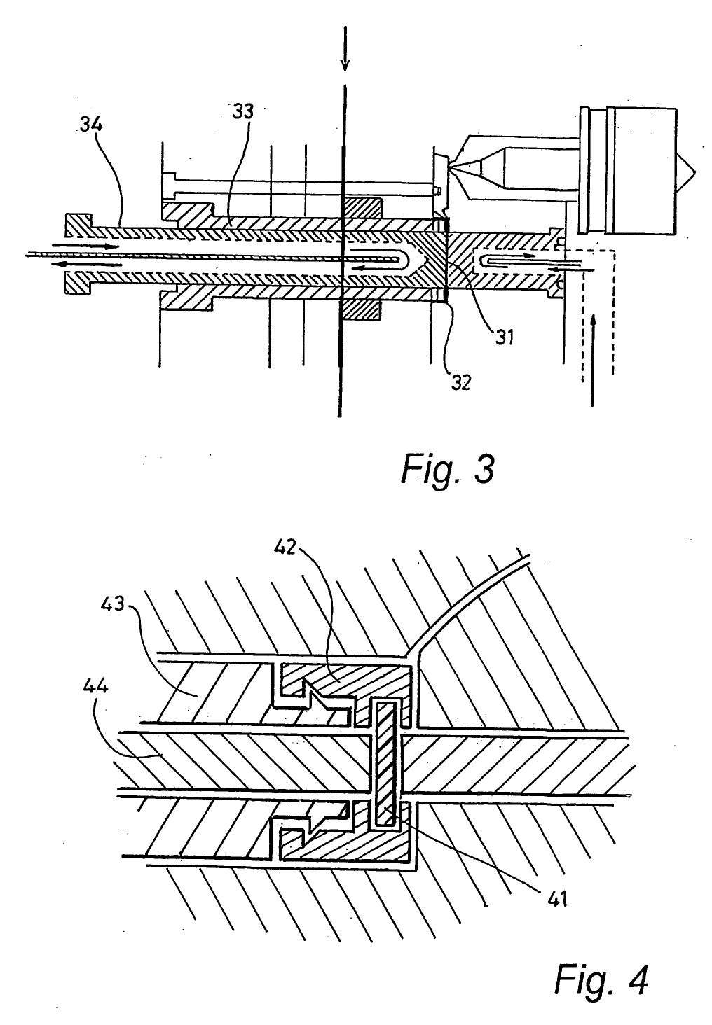

FIG. 3—shows a detail of the moulding equipment of FIG. 2, in the closed state; and

FIG. 4—shows a diagrammatic version of part of FIG. 3.

FIG. 1 is almost self-explanatory. It shows a section through a desiccant stopper (generally 11) of the invention. The stopper is of circular section, and thus is like a small pot.

The stopper has a main body portion (12) and a lid portion (13), and the top (as viewed) surface of the lid 13 is a “window” (14) made of a porous fibrous fabric sheet material sealed (at 15) all around its edge into the top edge of the lid's wall, and so effective integral therewith.

The lid 13 and body 12 are shaped (at 16) to be a snap fit. And when they are to be joined by a sonic welding technique their shape is also adjusted to be suitable for that method.

FIGS. 2a & B show general views of the moulding equipment (in the open and the closed states) needed to make the lid of FIG. 1. The mould (generally 21) is in three portions—a centre part (22), a top part (23: to the left as viewed) and a bottom part (24: to the right as viewed). The top part 23 also contains a punch (26) while the centre part 22 contains the punch cavity, and fed off a reel and though centre part is a web of membrane material (27). As the mould closes so the punch cuts out a small disc of membrane material, and carries it forward (to the right) into position ready to be fused with the lid plastic.

The centre portion 22 and the bottom portion 24 together make the volume defining the lid to be moulded. Once the mould is closed, the plastic is injected thereinto to make the lid, and as it does so it fuses to the membrane disc.

The working parts of the punch and mould are shown in more detail in FIGS. 3 and 4.

The moulding method and cycle is now discussed in more detail.

The mould is designed to produce the complete item in one operation. The size of the mould is determined by the size of the individual component required, but it is normal to manufacturer a mould with multiple cavities, to produce volume and lessen production costs. However, for the purpose of this application a single cavity mould is illustrated, to explain the cycle.

The requirement is to produce a moulding in plastic, which has as part of its construction, a previously separate membrane. At the start of the cycle, the membrane (31,41) is inserted into the mould cavity, and securely positioned. Whilst held in place, the plastic is formed around the exposed edges of the membrane at the time of injection, creating a frame (32,42: cross-hatched in FIG. 4) which securely anchors the edges only, leaving the centre of the membrane fabric exposed at the time of ejection.

The preferred method of insertion of the membrane, is to produce the membrane wad from reeled sheet form 27 during the moulding cycle, and to position the wad immediately after cutting.

During a standard method of injection moulding the moulding tool is made in a number of parts 22,23,24 which open and close during the cycle. For the purpose of this explanation the mould tool will be considered to have three separate sections which, combined, will constitute one mould tool. During the open part of the cycle the mould sections will separate to allow the cycle to begin.

The membrane material is available in reel form cut to choice of width. The reel is mounted adjacent to, but separate from the mould tool. The end of the reel length is passed through the centre section 22 of the three part mould, and wound onto the second (scrap) reel which is positioned to receive the web as it is passed through. The material on the feed reel is indexed to feed the correct length of material through the mould, and to ensure that waste is kept to a minimum.

The mould is closed in a predetermined way, assisted mechanically or hydraulically if required. During the closing part of the cycle, the web of membrane material is clamped securely between two metal plates. Each of the plates have a number of aligned holes, which are centred to the cavity/cavities of the mould. The holes described are sized to the required wad size.

When the mould is closed, a metal sleeve pin (33,43), correspondent in diameter to the size of the wad to be cut, and also to the size of the two metal plates' holes described above, is pushed forward, through the plates, and also through the web of membrane material which is trapped within. This forward action produces the necessary wad cleanly cut from the web and pushed forward into the cavity in one single motion. Situated within the sleeve pin is a spring-loaded solid pin (34,44), water-cooled to protect the membrane from heat damage, which travels forward to a distance further than the sleeve pin, to pinion the wad to the rear wall of the cavity. The rear wall of the cavity houses a water gallery to assist in the cooling, and protection of the wad during the plastic injection process.

The sleeve pin 33,43 and the internal solid pin 34,44 both stay forward during the injection process, and form the core to the moulding which is produced around their form.

After a period of cooling the mould opens to the greatest extent. The two pins are withdrawn from the cavity, pulling the moulding clear and ejecting as the snatch on the inside of the moulding is released. The two pins continue to travel backwards to the full extent of their back stroke, clear of the membrane material, through which they had been positioned during the mould closed portion of the cycle.

The membrane material is now indexed forward from the reel and the cycle is repeated as the mould closes again.

The scrap reel takes up the waste produced from each subsequent cycle.

1. A method for the production of a stopper suitable for use with a bottle of pills or the like, which stopper is of a thermoplastics material and is in the form of a pot at least one end face of which is made from a fibrous fabric sheet of a plastics material attached by fusion around its periphery to either the body of the pot or to a lid for the pot body, in which method the fibrous fabric sheet is held in place between the stopper body and the lid, and these two are then fused together so that on cooling and solidifying they form a solid, integral plastic supporting frame around the sheet embedded therein.

2. A method according to claim 1, in which the lid/body join is effected by sonic welding.

3. A method according to claim 1 or 2, in which the stopper has two membranes, one at either end.

4. A method according to claim 1, 2 or 3 in which the stopper is suitable for use with a bottle of pills or the like.

5. A stopper whenever made by a method as claimed in any of the preceding claims.
